(19) United States
(12) Patent Application Publication
(10) Pub. No.: US 2007/0295704 A1
(43) Pub. Date: Dec. 27, 2007

(54) ADDITIVES FOR IMPROVED WELDABLE COMPOSITES

(75) Inventors: David R. Sigler, Shelby Township, MI (US); Xiaohong Q. Gayden, West Bloomfield, MI (US); Yen-Lung Chen, Troy, MI (US); James G. Schroth, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/768,298

(22) Filed: Jun. 26, 2007

Related U.S. Application Data
(63) Continuation-in-part of application No. 11/017,419, filed on Dec. 20, 2004, now abandoned.

(51) Int. Cl. B23K 35/24; B23K 35/34

(52) U.S. Cl. 219/146.22; 219/146.31

(57) ABSTRACT

The present invention is directed to additives for improved weldable composites. A metal composite structure (10) features two metal members (12)(14) sandwiching a viscoelastic layer (26) where the viscoelastic layer entrains carbide-forming, carbon trapping particles (28) configured and sized to provide an effective inhibitor to carbon migration from the viscoelastic layer during welding.

The present application is a continuation-in-part of Applicant's copending U.S. application Ser. No. 11/017,419 filed on Dec. 20, 2004.

### I. BACKGROUND OF THE INVENTION

1. Field of the Invention

The present invention relates to metal composites. More particularly, the present invention relates to sound damping metal composites which include a viscoelastic layer having particles specifically selected and sized to inhibit carbon migration during spot welding.

2. Discussion of the Related Art

Metal composites are used to reduce noise and vibration in a wide range of applications. These applications include automobiles or other vehicles, machinery, appliances, power equipment and the like. These metal composites include a viscoelastic layer located between two metal structures, typically in sheet form. To allow for resistance spot welding, the viscoelastic layer has conductive particles distributed therein that facilitate electrical conduction through the composite during the welding process.

Several issues are encountered when the metal composites are resistance spot welded to other metal composites or solid steel panels. During the welding process, conductive particles near the welding electrode melt due to a combination of current flow through the particles and heat generated at the weld zone. In addition, discrete portions of the viscoelastic layer decompose in the region of the weld resulting in both generation of carbon containing species and high gas pressure. Tests have shown that the liquid produced from the melting particles, particularly if rich in iron or nickel, will react with the carbon containing species from the decomposed viscoelastic layer incorporating the carbon in the liquid. In the case of welding ferrous-based substrates, this carbon enriched liquid attacks and promotes carbon diffusion at the boundaries of the metal substrates, which degrades weld quality at the weld site from selectively localized melting and thinning of the substrate as well as the formation of hard carbon-rich areas in the fusion zone. When in sheet form or relatively thinner areas, the metallurgical and physical deterioration of the composite often result in the formation of blistering, i.e., bulging of the composite, or blow holes, i.e., perforation of the metal substrate.

No one in the prior art has attempted to address or remediate the phenomena of carbon migration. Accordingly, there exists a long felt, yet unresolved need in the art for a sound dampening composite that overcomes the problem of carbon migration.

The present inventors have achieved such a composite. As set forth in more detail herein, the present inventors have discovered that the use of specially selected and sized additives in the viscoelastic layer may successfully hinder or prevent the problems associated with carbon migration, whether it be by selecting additives in a quantity sufficient to trap carbon to the extent necessary to prevent blowholes or sheet perforations, in a quantity sufficient to completely hinder carbon moieties from contacting the metal sheets, or in a quantity to achieve results somewhere in between.

To be more specific, the present inventors have discovered that carbide forming materials may be dispersed in the viscoelastic layer in a quantity and manner to sufficiently react with carbon formed during welding to prevent and/or inhibit diffusion and/or migration of carbon from the viscoelastic layer into the metal sheet and metal article. The reactive particles contemplated by the inventors may be comprised of carbide forming elements including titanium, niobium, silicon, zirconium, and vanadium or compounds thereof such as iron-silicon or iron-titanium compounds, or any other material that may be sized and dispersed in a manner to achieve the advantageous features of the invention without any counterbalancing drawbacks counseling against their use as described in more detail below.

A previous artisan, Endo et al., fortuitously disclosed the use of certain metal particles that may fall within the class of carbide forming metals used in connection with the present invention, albeit for an entirely different purpose. Endo et al. in fact teaches away from the present invention and the composites of Endo et al. do not inherently include the advantageous aspects and features of the composites claimed herein. Specifically, while Endo et al. discloses the use of metal particles including chromium, nickel, and martenstitic stainless steel SUS 410 which arguably form some carbide during welding, the specific parameters taught by Endo et al. lead away from the present invention. For example, Endo et al. makes several explicit requirements for the particles in the viscoelastic material to achieve the desired results for the disclosed composites, including size, hardness, and conductivity. For the Endo et al invention to work the particles must be 80% to 100% of the laminate gap, must have a hardness greater than that of the metal skin sheets, and must possess good electrical conductivity.

An additional requirement of the particles of Endo et al. clear to one of ordinary skill in the art is that the particles must provide good corrosion and oxidation resistance to prevent the particles from degrading within the core. As will be appreciated, the materials disclosed by Endo et al. all have good oxidation resistance by forming a protective layer on the surface, Cr-oxide in the case of chromium and SUS 410 and Ni-oxide in the case of nickel. During electrical conduction, these particles would heat as they passed current, the protective oxide layers would thicken, and these layers would maintain their integrity for much longer periods than, for example, iron, iron-silicon alloys, titanium and the like.

Again, as will be appreciated by one of ordinary skill in the art, the protective oxide layers that form on chromium, nickel, and SUS 410 would make these particles behave poorly as far as reacting with carbon species formed in the core. The problems with Endo et al. are exacerbated by the size of the particles which further hinder reactivity due to a low surface to volume ratio for the particles. Moreover, the use of particles sized to match the gap, as suggested by Endo et al., has been shown in experiments to result in the problem of sheet perforations, which is the exact problem the present inventors sought to overcome. Although not wishing to be bound by theory, it appears that particles sized to match the gap, including carbide forming particles such as Fe-rich Fe-P particles that span the viscoelastic core gap result in these particles melting very early as current passes through them. Accordingly, even though they may inherently react with carbon as desired, due to them becoming molten and heated to high temperatures by current flow, they inevitably attack the substrate. In this sense, Endo et al. is the antithesis of the present invention.

### II. SUMMARY OF THE INVENTION

The present invention overcomes the drawbacks discussed above and offers new advantages as well. The metal composite of the present invention overcomes the limitations of the prior art and the teachings of Endo et al. as briefly described above by providing adhesive additives which, during the welding process, form an effective reactive barrier to carbon diffusion and/or migration into the metal substrates, or provide a carbon trap to inhibit carbon diffusion and/or migration. These reactive particles inhibit carbon-induced damage such as melting of ferrous-based alloy substrates.

According to an object of the invention, there is provided metal composite having a viscoelastic adhesive layer which includes carbide forming particles that are shaped to provide high surface to volume ratio. According to this object of the invention, an advantageous feature of the invention is the provision of flake or rod-shaped carbide forming particles in the viscoelastic layer. In accordance with this feature of the invention, in a preferred embodiment the particles have a flat or flake shape and are sized to fit within the viscoelastic core gap, wherein they have a length that is preferably less than 50% of the core gap, a width about the same dimension as the length, and a thickness of between about 10% and 50% of the particle length. In an alternative embodiment, the particles have a generally rod-shape configuration and include a length less than the viscoelastic core gap and a diameter preferably between about 10% to 50% of the particle length.

According to another object of the invention, the particles are also preferably composed of strong carbide forming elements that do not contain significant levels of elements that form protective oxide layers when heated.

According to yet another object of the invention, the amount of particles included in the viscoelastic layer is predetermined to ensure sufficient carbon trapping without degradation of the acoustic or mechanical performance of the composite. With automotive laminates, for example, the amount of particles is low enough, preferably less than 20% by volume, so as to not significantly degrade either the acoustic or mechanical performance of the laminate. With respect to the amount of particles to add to ensure sufficient carbide forming performance, the amount would be based on article volume and spacing relative to the viscoelastic layer thickness, particle aspect ratio, and the relative amounts of carbon that are contained in the viscoelastic polymer and carbide forming addition. A preferred amount for automotive laminates falls within the range of between 20% by volume to about 0.2% by volume, and more preferably, between about 10% by volume to 1% by volume.

According to these objects of the invention, there is provided a weldable metal composite, comprising, a first metal member and a second metal member, a viscoelastic layer disposed between said first and second metal members, said viscoelastic layer including carbon trapping additives where said additives inhibit migration of carbon containing moieties from the viscoelastic layer to both the metal member and melted conductive particles during welding of the composite and in the event that carbon is picked up by the melted conductive particles, the additives inhibit migration of carbon from the melted particles to the metal member.

The foregoing and other objects are satisfied by a method comprising the steps of making a sound damping metal composite for welding, comprising the steps of:

selecting a first metal member formed of a metal selected from the group consisting of low carbon steel, interstitial free steel, bake hardenable steel, high-strength low-alloy steel, transformation induced plasticity steel, martensitic steel, dual-phase steel, stainless steel.

selecting a second metal member formed of a metal selected from the group consisting of low carbon steel, interstitial free steel, bake hardenable steel, high-strength low-alloy steel, transformation induced plasticity steel, martensitic steel, dual-phase steel, stainless steel; and

applying a viscoelastic layer between said first metal member and said second metal member, said layer including carbon trapping additives where during welding of the composite said additives 1) inhibit migration of carbon containing moieties from the viscoelastic layer to both the metal members and melted conductive particles and 2) in the event that carbon is picked up by the melted conductive particles, inhibit migration of carbon from the melted particles to the metal member.

An aspect of the present invention is directed to a metal composite comprising a metal member having at least a first surface, and a metal article having at least a first juxtaposed surface. The metal member and metal article permit an electric current to flow there between during welding of the composite. A viscoelastic layer incorporating reactive additives is located between the first surface of the metal substrate and the first juxtaposed surface of the metal article. During welding of the composite, at least some of the reactive particles form a first reactive diffusion boundary associated with the first surface of the metal substrate, and form a second reactive diffusion boundary associated with the first juxtaposed surface of the metal article. The first and second reactive boundaries react with carbon generated within the viscoelastic layer, and thereby inhibit and/or prevent carbon diffusion and/or migration from the viscoelastic adhesive layer into the metal substrate and metal article during welding of the composite. In one embodiment of the invention the boundary is in the form of a discrete layer established by the reactive particles. In another embodiment of the invention, the reactive particles provide a sufficient carbon trap, without physical disposition or migration during welding to inhibit diffusion and/or migration of carbon into the metal substrate and metal article.

In one embodiment of the invention, the viscoelastic layer is a pressure sensitive adhesive and may include conductive particles to facilitate electric current flow between the metal substrate and the metal article during welding. The conductive particles may be composed of a material selected from the group consisting of iron, nickel, chromium, copper, aluminum and electrically conductive alloys and compounds thereof. The reactive particles may be composed of a material selected from the group consisting of titanium, niobium, silicon, zirconium, and vanadium or alloys and compounds thereof, or any other material that is a good carbide former while not forming an overly protective oxide layer. Preferably, the reactive particles have a melting point between about 500° C. and about 2000° C. In operation, the reactive particles establish a carbon trap for reacting with carbon in the adhesive layer during welding of the composite to preferably form carbide and thereby provide an effective boundary against migration of the carbon into the melting conductive particles and adjacent metal elements as well as reduce the level of carbon in the gaseous decomposition products.

Another aspect of the present invention is directed to a method of making a metal composite including applying a viscoelastic layer incorporating reactive carbon-trapping particles between an interior surface of a metal substrate and a juxtaposed surface of a metal article. During welding of the composite, at least some of the trapping reactive particles establish a boundary against migration of carbon to prevent migration into the adjacent metal members. The reactive particles exhibit a propensity for carbide formation with a resulting preference for absorption of carbon released in the viscoelastic layer. Consequently, the particles retard carbon diffusion and/or migration into the adjacent metal members and melted conductive particles during welding of the composite. The resulting metal composite is sound damping and typically has a total thickness between about 0.30 mm and about 3.00 mm.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, which is shown by way of illustration to the specific embodiments in which the invention may be practiced. The following embodiments are described in sufficient detail to enable those skilled in the art to practice the invention. It is to be understood that other embodiments may be utilized and that structural changes based on presently known structural and/or functional equivalents may be made without departing from the scope of the invention. Given the following description, it should become apparent to the person having ordinary skill in the art that the invention herein provides a laminated, sound/vibration damping composite and method providing significantly augmented efficiencies while mitigating problems of the prior art.

The accompanying figure shows an illustrative embodiment of the invention from which these and other of the objectives, novel features and advantages will be readily apparent.

### III. BRIEF DESCRIPTION OF THE DRAWING

FIG. 1 is a cross-sectional view of a metal composite made in accordance with the present invention.

### IV. DETAILED DESCRIPTION OF THE PREFERRED EMBODIMENTS

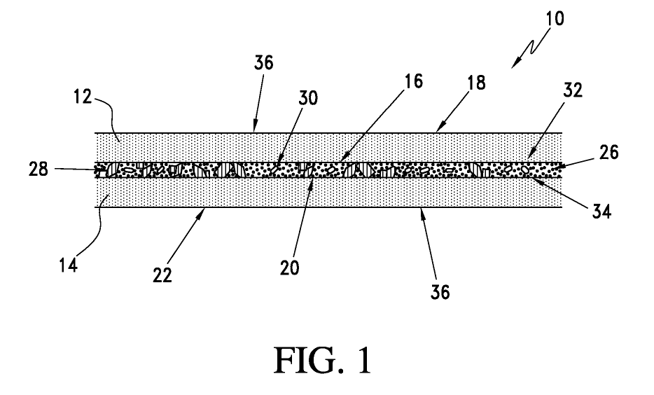

Referring to FIG. 1, shown is a metal composite 10 comprising a metal sheet 12 and a metal article 14. The metal article 14 may be any shape, including but not limited to a sheet; a longitudinal member including a tube, such as a hydroformed tube or a rail, such as a rail section in a vehicle. In a preferred embodiment, the metal article 14 is a metal sheet as illustrated in FIG. 1. The metal sheet 12 includes an interior surface 16 and an exterior surface 18. Similarly, the metal article 14 has a first surface 20 and a second surface 22. The first surface 20 of the metal article 14 may be an interior surface, and the second surface 22 of the metal article may be an exterior surface. The metal sheet 12 and metal article 14 may be comprised of any metal suitable for welding, including but not limited to steel. Preferably, the metal sheet 12 and metal article 14 are comprised of steel, including but not limited to low carbon, interstitial free, bake hardenable, high strength low alloy, transformation induced plasticity (TRIP), martensitic, dual phase, or stainless steel.

A viscoelastic layer 26 is located between the interior surface 16 of the metal sheet 12 and the first surface 20 of the metal article 14. The viscoelastic layer 26 may be comprised of any adhesive known to those having skill in the art which is effective in bonding the metal sheet 12 and the metal article 14 together. The layer 26, is preferably a viscoelastic resin such as a pressure sensitive adhesive, including but not limited to a poly(isoprene:styrene) copolymer or a poly alkyl acrylate. Preferably, the pressure sensitive adhesive is comprised of a poly(isoprene:styrene) copolymer. The adhesive layer typically has a thickness between about 0.005 mm and about 0.200 mm. Preferably, the adhesive layer is between about 0.02 mm and about 0.05 mm thick.

Conductive particles 28 may be located between the interior surface 16 of the metal sheet 12 and the first surface 20 of the metal article 14. The conductive particles 28 allow an electric current to initially flow between the metal sheet 12 and the metal article 14 during welding of the metal sheet and metal article. The conductive particles 28 are typically located within the adhesive layer 26. As the composite 10 is welded, the metal sheet 12 and the metal article 14 are forced closer together which causes the area or gap between the interior surface 16 of the metal sheet and the first surface 20 of the metal article to decrease. Each conductive particle 28 is sized to alone, or in combination with at least one additional conductive particle, to bridge the area between the interior surface 16 of the metal sheet 12 and the first surface 20 of the metal article 14 during welding of the composite 10. Alternatively, agglomerates of smaller sized conductive particles 28 are sized to bridge the gap between the metal sheet 12 and the metal article 14. The conductive particles 28 may be comprised of any material which allows electricity to flow between the metal sheet 12 and the metal article 14 during welding. Suitable materials include, but are not limited to pure metals such as iron, nickel, chromium, copper, aluminum, or any electrically conductive alloys or compounds thereof, including iron phosphide. Preferably, the conductive particles 28 are comprised of nickel.

The viscoelastic layer 26 incorporates flakes or rods of reactive particles 30. During welding of the composite 10, at least some of the reactive particles 30 disposed under the welding electrode melt, and establish a carbon trap that, when molten, under hydraulic pressure, may spread to form a discrete reactive boundary (illustrated as boundary 32) located on the interior surface 16 of the metal sheet 12. A corresponding boundary 34 may form adjacent to the first surface 20 of the metal article 14. Each of the boundaries 32 and 34 may assume the form of a continuous layer, a discontinuous layer, or may be admixed through the viscoelastic layer 26. In the region of the weld, the reactive boundaries 32 and 34 typically assume the form of a discontinuous layer. The reactive boundaries 32 and 34 and any remaining reactive particles 30 in the vicinity of the weld possess a preference for elemental carbon and gaseous organics by reacting with such moieties to preferably form carbides. This reaction removes the moieties and prevents and/or inhibits the diffusion and/or migration of carbon from the layer 26 into the adjacent metal elements or melted conductive particles during welding. Conductive particles that also react with carbon, such as the Ni, Cr, and SUS 410 particles described by Endo, heat and melt quickly as current flow begins during welding. These particles react with carbon, which depresses their melting point, and the combination of high temperature and depressed melting point causes the particles to aggressively attack the substrate forming perforations.

The reactive particles 30 preferably have a lower melting point than the metal sheet 12 and the metal article 14, thereby providing intermixed boundaries and even forming reactive boundaries 32 and 34 during the welding process prior to melting of the metal sheet and metal article. Preferably, the reactive particles 30 have a melting point between about 500° C. and 2000° C. More, preferably, the reactive particles 30 have a melting point between about 1000° C. and about 1500° C.

The reactive particles 30 are composed of any suitable material which does not form an overly protective oxide layer while also exhibiting a strong preference for binding with organic decomposition products and elemental carbon from the viscoelastic layer 26 to prevent and/or inhibit diffusion and/or migration of carbon therefrom directly into the metal sheet 12 and metal article 14 or indirectly through the molten conductive particles during welding of the composite 10. The reactive particles 30 may be comprised of carbide forming elements that do not form protective, i.e., continuous, compact, and adherent, oxide layers such as titanium, niobium, silicon, zirconium, and vanadium or alloys or compounds thereof such as iron-silicon or iron-titanium alloys. In a presently preferred embodiment, the reactive particles are comprised of titanium.

In Applicant's co-pending prior [symbol] No. 11/017,419 filed on Dec. 20, 2004, the present inventors disclosed composites making use of carbon trapping reactive particles. While the present invention, particularly in the case of titanium particles, may be practiced with spherical and/or large particles if the particles selected are good carbide formers that do not suffer the drawback of forming protective oxide layers (as is the case with chromium, nickel and SUS 410), presently preferred are reactive particles chosen for increased reactivity. Specifically, the present invention contemplates use of reactive particles having optimized reactivity reached through advantageous particle composition and particle shape.

With respect to particle composition, as previously mentioned, it is desirous to select particles that do not contain significant levels of elements that form protective oxide layers. Such elements include chromium, nickel, and aluminum, which, as will be appreciated by one of ordinary skill in the art, are used extensively in various oxidation resistant alloys in various degrees because they are effective at forming protective oxide layers. These oxide layers are continuous, compact, and tenacious, thus acting as barriers to the sought after reaction with carbon of the present invention.

With respect to particle shape, as previously mentioned, it is desirous to select particles that have a high surface to volume ratio. As will be appreciated, this will provide increased surface area for the reaction with carbon moieties to occur. To elaborate, the particle with the minimum surface to volume ration that would fit inside the viscoelastic core gap would be a spherical particle of the same size as the gap. Such sized particles, if harder than the metal sheets, are disclosed in Endo et al. due to the deformation of the metal sheets when the composite is compressed providing a direct current path for electrical welds between the two sheets. While particles of this size are contemplated by the inventors to be within the scope of the invention, particles of this size are the poorest size and shape for reacting with carbon. Moreover, experiments performed by Applicant have shown that using carbide forming particles such as Fe-rich Fe-P particles that span the viscoelastic core gap results in the particles becoming molten and heated during welding to the point that they attack the substrate and cause the perforations that the present invention is trying to avoid.

Presently preferred particle shapes include flake and rod-shape configurations due to their high surface to volume ratios. With respect to flakes, which have the greatest surface to volume ratio, preferred dimensions include a length less than the viscoelastic core gap, preferably less than 50% of the viscoelastic core gap, a width less than or about the same dimension length, and a thickness preferably between 10% and 50% of the particle length. With respect to rod-shaped particles, preferred dimensions to ensure the particles fit within the viscoelastic core gap include a length less than the core gap, and preferably <50% of the core gap, and a diameter preferably between 10% and 50% the particle length.

One of ordinary skill in the art armed with the present application will appreciate that the composition and size of the particles may be selected and adjusted based on the composition of the metal skins, the adhesive layer, the type of welding equipment, the amount of carbon migration expected to be encountered, etc. and such modifications and selections are well within the ability of the ordinary skilled artisan through routine experimentation. All such modifications and adjustments should be deemed within the scope of the present invention.

Likewise, the amount of reactive particle material to include in the composite is also to be understood as being based on the results such to be achieved, the materials of construction, the type of welding involved, etc. For example, with automotive sound dampening laminates, there are two considerations to take into account, 1) the mechanical and acoustical performance of the end product and 2) the carbide forming ability of the additive. With respect to mechanical/acoustical performance, the amount of the addition should be low enough so it will not significantly degrade either acoustic or mechanical performance of the laminate. To this end, it is presently preferred that the addition be kept less than 20% by volume. However, it is well within the ability of one of ordinary skill in the art to select or optimize the amount of reactive addition through routine experimentation, and all such modifications should be viewed as within the scope of the invention.

With respect to carbide forming performance, again, the amount to include would be based on the specifics involved and factors such as particle volume and spacing relative to the viscoelastic layer thickness, particle aspect ratio, and the relative amounts of carbon that are contained in the viscoelastic polymer and carbide forming addition assuming it has fully reacted in the composite. A presently preferred range of additive to be effective reacting with carbon would be from about 20% by volume to about 0.2% by volume, and more preferably, a range from about 10% by volume to about 1% by volume. However, it is well within the ability of one of ordinary skill through routine experimentation or calculations to select or optimize the range to achieve the desired performance and all such modifications should be viewed as within the scope of the invention.

The composite 10 may include a coating 36 located on the exterior surface 18 of the metal sheet 12 and the second surface 22 of the metal article 14. The coating 36 may be comprised of any material known to those having skill in the art which is capable of preventing and/or inhibiting corrosion or rusting of the metal sheet 12 and metal article 14. Preferably, the coating 36 is a zinc-containing coating such as a hot dip galvanized, electrogalvanized, or galvanneal coating for ferrous substrates.

Welding the composite 10 of the present invention may include welding the metal sheet 12 to the metal article 14, or it may include welding the entire composite to another structure or material. The composite 10 of the present invention is suitable for various types of welding including, but not limited to drawn arc welding and resistance welding including resistance spot welding and projection welding.

The composite 10 of the present invention possesses sound damping and vibration damping qualities. When in sheet form, as illustrated in FIG. 1, the composite 10 typically has a thickness between about 0.30 mm and about 3.00 mm and preferably, has a total thickness between about 0.6 mm and about 1.5 mm. When in a substantially sheet-like form, the composite 10 is useful for numerous sound damping applications including, but not limited to use in automobiles or other vehicles, machinery, business equipment, appliances and power equipment. For example, the composite 10 may be used in the plenum, front of dash or floorpan of an automobile.

The present invention is also directed to a method of making a composite 10 described above. By way of example, in the illustrated sheet form, the method includes the step of applying a viscoelastic layer 26 between the juxtaposed interior surface 16 of a metal sheet 12 and the first surface 20 of a metal article 14. The viscoelastic layer 26 preferably is a pressure sensitive adhesive that may be applied by any method known to those having skill in art, including but not limited to extrusion, roll coating, or spray coating. As described above, the layer 26 entrains reactive particles 30 some of which, during welding, melt and redistribute within the composite to establish carbon anti-migration boundaries. The boundaries exhibit a thermodynamic preference for organic moieties formed during welding reacting therewith to establish effective carbon anti-migration boundaries and carbon traps within the composite. Thus, practice of the invention minimizes damage to the metal composite resulting from carbon migration from decomposition of the viscoelastic of the composite 10.

Specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A weldable metal composite, comprising:
a first metal member and a second metal member;
a viscoelastic layer disposed between said first and second metal members, said viscoelastic layer including carbon trapping particles sized and configured to inhibit carbon pick up and migration of carbon containing moieties from the viscoelastic layer to the metal members during welding of the composite.

2. The weldable composite of claim 1, wherein said carbon trapping particles have a rod-shaped configuration.

3. The weldable composite of claim 1, wherein said carbon trapping particles are in the form of flakes.

4. The metal composite according to claim 1 where during welding said carbon trapping particles establish at least one carbide-forming boundary between said viscoelastic layer and at least one of said metal members.

5. The metal composite according to claim 1 where said viscoelastic layer is a pressure sensitive adhesive further comprising electrically conductive particles dispersed therethrough and where the composite exhibits sound damping properties.

6. The metal composite according to claim S where said pressure sensitive adhesive is selected from the group consisting of poly(isoprene:styrene} and poly (alkyl acrylate).

7. The metal composite according to claim 6 wherein said electrically conductive particles are selected from the group consisting of iron, nickel, copper, aluminum, and electrically conductive alloys and compounds thereof.

8. The metal composite according to claim 1, wherein said first metal member and said second metal member are composed of a material selected from the group consisting of steel and steel alloys.

9. The metal composite of claim 1, wherein first and second metal members possess a substantially sheet-like form and comprise steel selected from the group consisting of low carbon, interstitial free, bake hardenable, high strength low alloy, transformation induced plasticity, martensitic, dual phase, and stainless steel.

10. The metal composite of claim 4, wherein said carbon trapping particles defines a discontinuous boundary layer.

11. The metal composite of claim 4, wherein said carbon trapping particles define a continuous boundary layer.

12. A method of making a sound damping metal composite for welding, comprising the steps of:
selecting a first metal member formed of a metal selected from the group consisting of low carbon steel, interstitial free steel, bake hardenable steel, high-strength low-alloy steel, transformation induced plasticity, martensitic, dual-phase steel, stainless steel and alloys thereof susceptible to carbide formation;
selecting a second metal member formed of a metal selected from the group consisting of low carbon steel, interstitial free steel, bake hardenable steel, high-strength low-alloy steel, transformation induced plasticity, martensitic, dual-phase steel, stainless steel, and alloys thereof susceptible to carbide formation; and
applying a viscoelastic layer between said first metal member and said second metal member, said layer including carbon trapping particles sized and configured to inhibit migration of carbon containing moieties from the viscoelastic layer to the metal members during welding of the composite.

13. The method of claim 12, further comprising the step of:
dispersing conductive particles within the viscoelastic layer.

14. The method of claim 13 further comprising the step of:
resistance spot welding the composite whereby said carbon trapping particles melt and react with carbon to form carbides and to thereby inhibit carbon diffusion from the viscoelastic into the metal members.
